(19) United States
(12) Patent Application Publication
(10) Pub. No.: US 2026/0068874 A1
(43) Pub. Date: Mar. 12, 2026

(54) AGROCHEMICAL FORMULATION SOLVENTS

(71) Applicant: Rosen's, Inc., Liberty, MO (US)

(72) Inventor: Matthew T. Meredith, Spring, TX (US)

(21) Appl. No.: 19/325,037

(22) Filed: Sep. 10, 2025

Related U.S. Application Data
(60) Provisional application No. 63/692,924, filed on Sep. 10, 2024.

(51) Int. Cl. A01N 25/02; A01P 7/04

(52) U.S. Cl. CPC A01N 25/02; A01P 7/04

(57) ABSTRACT

Solvents for agrochemical formulation with lesser toxicity and at least comparable physiochemical characteristics as compared to existing agrochemical solvents are described. The solvent may have similar or higher flash point than existing agrochemical solvents. The solvent may have the same or lesser hygroscopicity than existing agrochemical solvents. The solvent may prevent crystallization or precipitation of the agrochemical formulation at temperatures below or equal to zero degrees Celsius.

### CROSS REFERENCE TO RELATED APPLICATIONS

This application claims priority to copending U.S. provisional patent application 63/692,924 to Matthew T. Meredith filed Sep. 10, 2024, entitled “Agrochemical Formulation Solvents,” incorporated herein by reference.

### TECHNICAL FIELD

The present disclosure relates to the use of solvents in agrochemical formulations.

### BACKGROUND

Agrochemical solvents can vary widely in their chemical structures and properties and may be used to dissolve and deliver various agrochemical active ingredients. A limited number of agrochemical solvents may be available to dissolve agrochemical active ingredients as some are considered hazardous substances and under regulatory pressure in many countries or are already banned. Regulatory barriers for new molecules may be high in most countries, such that it may be difficult for new solvents to enter the industrial chemical market, especially the agrochemical market. There is a need for a solvent that has low toxicity and favorable properties for dissolving agrochemical active ingredients.

### SUMMARY

The disclosure describes an agrochemical formulation including an agrochemical active ingredient and a solvent for dissolving the agrochemical active ingredient. The solvent may include at least one heterocyclic compound having a ring structure and at least one nitrogen and one oxygen in the ring structure.

An agrochemical formulation may include a nitrogen stabilizer for reducing nitrogen loss from a nitrogen fertilizer and a solvent for dissolving the nitrogen stabilizer. The solvent may include at least one heterocyclic compound having a ring structure and at least two heteroatoms in the ring structure. The solvent may be selected to prevent crystallization or precipitation of the agrochemical formulation at temperatures below or equal to zero degrees Celsius.

A method of producing an agrochemical formulation may include dissolving an agrochemical active ingredient in a solvent. The solvent may include at least one heterocyclic compound having a ring structure and at least one nitrogen and one oxygen in the ring structure.

A method of producing an agrochemical formulation may include dissolving a nitrogen stabilizer in a solvent. The solvent may include at least one heterocyclic compound having a ring structure and at least two heteroatoms in the ring structure. The solvent may be selected to prevent crystallization or precipitation of the agrochemical formulation at temperatures below or equal to zero degrees Celsius.

A method of delivering an agrochemical formulation to plants or soil includes applying a mixture of a plant-targeted or soil-targeted agrochemical additive dissolved in a solvent comprising at least one heterocyclic compound to a plant-targeted or soil-targeted agrochemical input. The solvent may have a hygroscopicity characterized by less than 6% increase in weight after the solvent was placed in a humidity chamber set at 33.5 degrees Celsius and 60% relative humidity for four hours to prevent clumping of the plant-targeted or soil-targeted agrochemical input when the plant-targeted or soil-targeted agrochemical additive is combined with the plant-targeted or soil-targeted agrochemical input. The solvent may be selected to prevent crystallization or precipitation of the agrochemical formulation at temperatures below or equal to zero degrees Celsius.

### BRIEF DESCRIPTION OF THE DRAWINGS

The disclosure can be understood in consideration of the following detailed description of various embodiments in connection with the accompanying drawings.

FIG. 1 shows the hygroscopicity results for DMSO, NMP, DMAc, and MeOx.

FIG. 2 shows the moisture absorption by fertilizer coated with Comparative Example 2 formulation without MeOx and Example 3 formulation without MeOx.

FIG. 3 shows the hygroscopicity results for urea, urea with DMSO, urea with NMP, and urea with MeOx.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

To solve the problem of providing a low toxicity solvent with favorable properties for dissolving agrochemical active ingredients, the present disclosure provides a polar aprotic solvent that has lower toxicity than some existing solvents (e.g., DMSO, NMP, DMAc) with favorable characteristics (e.g., compatibility with other components of the formulation, low hygroscopicity, high flash point, preventing crystallization or precipitation) for dissolving the agrochemical component (e.g., nitrogen stabilizers). In particular, the present disclosure provides a solvent with a lower toxicity than NMP and DMAc, and a lower hygroscopicity than DMSO, which is also less toxic than NMP and DMAc. As such, the present disclosure presents a solvent with a unique combination of low toxicity, moisture resistance, and agrochemical dissolving properties.

Several references identify solvents, but fail to recognize the problem of providing a low toxicity solvent with favorable properties for dissolving agrochemical active ingredients or provide a solution that includes a polar aprotic solvent that has lower toxicity than some existing solvents (e.g., DMSO, NMP, DMAc) with favorable characteristics (e.g., compatibility with other components of the formulation, low hygroscopicity, high flash point, preventing crystallization or precipitation) for dissolving the agrochemical component (e.g., nitrogen stabilizers). For example, the article by Huffman et al., entitled “Liquid 2-Oxazolidones. I. Dielectric Constants, Viscosities, and Other Physical Properties of Several Liquid 2-Oxazolidones,” describes physical properties of derivatives of 2-oxazolidone. The article by Jackson et al., entitled “Several Properties of the Dimethyl Sulfoxide-3-Methyl-2-oxazolidone System as Functions of Composition and Temperature,” describes physical properties of derivatives of mixtures including 3-methyl-2-oxazolidone. The article by Marchall et al., entitled “3-Methyl-2-oxazolidinone (JEFFSOL® MEOX) as a Substitute Solvent for NMP in Battery Manufacturing,” describes 3-methyl-2-oxazolidinone as a substitute solvent for Li-ion batteries. The article by Gzara et al., entitled “Is 3-methyl-2-oxazolidinone a suitable solvent for lithium-ion batteries?,” discusses use of 3-methyl-2-oxazolidinone as an electrolyte in Li-ion batteries. U.S. Pat. No. 2,755,286, to Bell et al., describes production of oxazolidones, the entirety of which is incorporated by reference herein. International Patent Application No. WO2024147895A1 by Zhou et al., describes a process for preparing an n-substituted-2-oxazolidinone, the entirety of which is incorporated by reference herein. International Patent Application No. WO2025155650A1, by Zhang et al., describes solvent blend including a substituted oxazolidinone and one or both of an alkylene glycol and an alkylene carbonate or hydroxy-derivative thereof, the entirety of which is incorporated by reference herein.

The agrochemical formulation includes a solvent and an active ingredient. In some examples, the agrochemical formulation includes a solvent, an active ingredient, and at least one co-solvent. In some examples, the agrochemical formulation includes a solvent, active ingredient, at least one co-solvent, and at least one additive. In some examples, the agrochemical formulation includes a solvent, an active ingredient, at least one co-solvent, and a dye. In some examples, the agrochemical formulation includes a solvent, an active ingredient, at least one co-solvent, a dye, and a surfactant.

An active ingredient is the component of a product that is primarily responsible for its intended effect or activity. In an agrochemical formulation, the active ingredient is the substance that directly produces the desired outcome or agricultural effect. An agrochemical formulation may include at least one active ingredient. For example, the agrochemical formulation may include a primary active ingredient and a secondary active ingredient. The secondary active ingredient may be an additive that supports the function of the primary active ingredient. In some examples, the active ingredient includes a secondary active ingredient (e.g., agricultural additive). In some examples, the active ingredient includes a primary active (e.g., agricultural input) ingredient and a secondary ingredient (e.g., agricultural additive).

Agricultural inputs may include agrochemical inputs, such as chemicals and substances used in agriculture. Examples of agrochemical inputs include fertilizers, pesticides, herbicides, insecticides, soil conditioners, plant growth regulators, plant growth hormones, biostimulants, microbes, sporulated microbes, nutrients, defoliants, desiccants, and soil amendments. Biostimulants are substances or microorganisms that enhance plant growth, stress resistance, and nutrient use efficiency. Biostimulants may be a fertilizer uptake enhancer. Examples of biostimulants include humic substances, seaweed extracts, amino acids, plant extracts, beneficial bacteria, mycorrhizal fungi, beneficial yeasts, polysaccharides, plant hormones, humic and fulvic acids, vitamins, organic acids, and silicon-based compounds. The biostimulant may include an amino acid, such as a polyamino acid. The polyamino acid may include polyaspartic acid, a type of polyamino acid derived from aspartic acid. Polyaspartic acid may be considered a biostimulant and a fertilizer uptake enhancer; it may chelate hard water ions in the soil, helping to free up more phosphates, and making them more available for the plant roots to absorb. An agrochemical input may be a crop production chemical, which generally refers to substances used in agriculture to support and enhance the growth, health, and yield of crops. A crop production chemical may include plant-targeted or soil-targeted chemicals that chemically interact with plants and/or soil. Examples of crop production chemicals include fertilizers, growth regulators, soil amendments, and plant nutrients. An agrochemical input may include concentrated chemicals having a high concentration of an active component (e.g., nitrogen, potassium phosphate, calcium, magnesium, and micronutrient), such as nitrogen fertilizers, nitrogen herbicides, potassium fertilizers, phosphate fertilizers, calcium fertilizers, magnesium fertilizers, and micronutrient fertilizers.

An agrochemical additive may be a substance added to an agrochemical formulation having an agrochemical input to improve the performance or enhance the beneficial properties of the agrochemical input. Examples of agrochemical additives include fertilizer additives, pesticide additives, adjuvants, surfactants, pH adjusters, humectants, anti-foaming agents, preservatives, and anti-caking agents.

An agrochemical formulation may include an agrochemical input of a concentrated chemical having a high concentration of an active component (e.g., nitrogen, potassium phosphate, calcium, magnesium, and micronutrient) and an agrochemical additive for supporting the concentrated chemical (e.g., reducing the loss of the active component). The agrochemical input may include a nitrogen fertilizer, which can provide essential nitrogen to plants, promoting growth and increasing crop yield. Examples of nitrogen-based fertilizers include urea, urea-ammonium nitrate, ammonium sulfate, ammonium phosphates, and mixtures thereof. Because nitrogen in fertilizers can be lost to the environment through processes like volatilization, leaching, and denitrification, an agrochemical additive, such as a nitrogen stabilizer may be applied to (e.g., coated onto) the nitrogen fertilizer to extend the lifetime of the nitrogen fertilizer in the soil.

An agrochemical formulation may include a nitrogen stabilizer. Nitrogen stabilizers may enhance the efficiency of nitrogen-containing fertilizers in agriculture by reducing nitrogen losses and improving the availability of nitrogen to crops, improving crop yield, and reducing environmental impact. Nitrogen stabilizers may reduce nitrogen loss by interacting with nitrogen-containing compounds in the soil, such as by inhibiting urease activity, inhibiting nitrification, or controlling the release of nitrogen. Urease inhibitors slow down the conversion of urea into ammonia gas, reducing the potential for nitrogen loss through volatilization. Nitrification inhibitors slow down the conversion of ammonium into nitrate, reducing the potential for nitrogen loss through leaching and denitrification. Some nitrogen stabilizers help in the controlled release of nitrogen from fertilizers, ensuring that it is available to plants over a longer period, which reduces the risk of loss.

Nitrogen stabilizer compounds may include thiophosphoric triamide, dicyanamide, di-alkylpyrazole salt, or mixtures thereof. Examples of nitrogen stabilizers include N-(n-butyl) thiophosphoric triamide (NBPT), N-(n-propyl)thiophosphoric triamide (NPPT), dicyandiamide (DCD), 3,4-dimethylpyrazole phosphate (DMPP), nitrapyrin, sulfur-coated fertilizers, and polymer-coated fertilizers. NBPT and NPPT may be classified as urcase inhibitors, which work by inhibiting the urease enzyme in soil, preventing the urease enzyme from converting urea into ammonia. DMPP, DCD, and nitrapyrin may be classified as nitrification inhibitors, which work by inhibiting part of the enzyme cascade in certain bacteria that convert ammonia to nitrate, thereby reducing nitrogen leaching in soils. Sulfur-coated fertilizers and polymer-coated fertilizers may be classified as controlled-release fertilizers, where fertilizers coated with sulfur or polymers can regulate the release of nitrogen from urea.

Nitrogen stabilizers may be molecules focused on their reactivity and ability to inhibit specific soil enzymes or microbes. Nitrogen stabilizers may contain specific functional groups that interact with specific enzymes or microbial processes in the soil. Functional groups of nitrogen stabilizers that target soil enzymes include thiophosphoric amide group (—PS(NH₂)₂), phosphoramidate group (—P(O)(NH₂)(OR)), pyrazole ring structure, sulfonyl group (—SO₂), cyanamide group, and aromatic rings with substituents.

The thiophosphoric amide group in NBPT can mimic the substrate of urease (urea) and bind to the enzyme's active site. This may block the conversion of urea into ammonia and carbon dioxide, slowing down nitrogen loss through ammonia volatilization. Similar to thiophosphoric amides, phosphoramidates can inhibit urease by binding to its active site, preventing the enzyme from catalyzing the hydrolysis of urea.

The chlorinated pyridine derivative group in nitrapyrin can inhibit ammonia monooxygenase, an enzyme responsible for the first step in the nitrification process, which converts ammonium to nitrite. This inhibition may slow down the conversion of ammonium to nitrate, reducing nitrogen leaching and denitrification losses. The pyrazole ring structure in DMPP can interact with the active site of nitrification enzymes, inhibiting their activity and slowing down the conversion of ammonium to nitrate. DCD can release cyanamide, which may inhibit the activity of nitrifying bacteria by affecting ammonia monooxygenase, thereby reducing the rate of nitrification. Nitrapyrin contains a substituted aromatic ring with chlorine atoms that can target the enzyme ammonia monooxygenase. The presence of the chlorine substituents may enhance the ability of nitrapyrin to bind to and inhibit the enzyme, thereby reducing the rate of nitrification by preventing the conversion of ammonia to nitrate.

The sulfonyl group can act as an electrophile, interacting with nucleophilic sites in enzymes, leading to enzyme inhibition. However, this may be more common in herbicide action than in nitrogen stabilization.

For the preparation of an agrochemical formulation of the nitrogen stabilizer, a solvent may be included. Solvents can be aromatic oils, paraffinic oils, triglycerides, amides, esters, amines, alcohols, ethers, sulfoxides, or other more exotic chemical classes. The disclosed solvent system may demonstrate reduced toxicity relative to existing solvents such as N-methylpyrrolidone (NMP) and dimethylacetamide (DMAc), improved hygroscopicity relative to existing solvents such as dimethylsulfoxide (DMSO), and maintain or improve comparable properties, including flash point.

The toxicity of solvents may be characterized by LD 50 (oral, rat), LD₅₀ (dermal, rabbit), EPA classification as a reproductive hazard, and skin absorption. The LD₅₀ (oral, rat) values help gauge the toxicity of a substance when ingested by indicating the dose needed to cause death in 50% of the test population. The LD₅₀ (dermal, rabbit) values help gauge the toxicity of a substance when applied to the skin by indicating the dose needed to cause death in 50% of the test population. Suitable solvents may have an LD₅₀ (oral, rat) of at least 1000 mg/kg and LD₅₀ (dermal, rabbit) of at least 500 mg/kg.

The EPA or other regulatory agencies may categorize a substance under various levels of reproductive hazard classifications. Category 1A substances are known to have effects on reproductive health based on human evidence. Category 1B substances are known to have effects on reproductive health based on animal evidence or other information indicating a potential for harm to human reproduction. Category 2 substances are suspected of causing reproductive toxicity based on animal evidence or other information indicating a potential for harm to human reproduction but with less certainty than Category 1A or 1B. Not classified include chemicals with insufficient evidence to make a determination regarding reproductive toxicity; these are not categorized under reproductive hazards but should still be handled with appropriate care. Suitable solvents should not be categorized as a reproductive hazard by EPA or other regulatory agencies.

Skin absorption may be a factor in assessing the toxicity and dangers of handling a substance. High skin absorption may increase the risk of systemic toxicity and underscore the importance of proper safety measures to prevent harmful exposure. Skin absorption may be quantified as permeation rate and flux. Permeation rate or permeability coefficient (Kp) is a quantifiable measure of how much of a substance passes through the skin per unit area per unit time. Flux is the amount of a chemical absorbed through the skin over time. Suitable solvents may have a permeability coefficient of less than 2.0×10⁻³ cm/s, less than 1.4×10⁻⁴ cm/s, or less than 1.0×10⁻⁴ cm/s. Suitable solvents may have a flux of less than 100 to 1,000 μg/cm²/h, less than 10 to 100 μg/cm²/h, or less than 1 to 10 μg/cm²/h.

Suitable solvents may have a flash point temperature equal to or higher than any temperature between 39° C. and 87° C., inclusively. For example, the solvent may have a flashpoint greater than 86° C.

Suitable solvents may have comparable or less hygroscopicity than NMP, DMSO, and DMAc. When a solvent has higher hygroscopicity than other solvents, the solvent may be more prone to absorbing moisture during storage, which can cause active ingredient degradation, or can cause excessive clumping of an active ingredient that the solvent is sprayed onto (e.g., fertilizer). Hygroscopicity may be determined by the percent change in weight due to moisture absorption of a solvent placed in a humidity chamber set at 33.5° C. and 60% relative humidity (RH) over a duration of time, such as 4 hours. The percent water absorbed may be based on the percent change in weight, which may be calculated from the change in weight of the solvent after four hours in the humidity chamber and the original weight of the solvent before being placed in the humidity chamber. A suitable solvent hygroscopicity may have a percentage water absorbed of equal to or less than any numeric percent between 5.5% and 20%. For example, the solvent may have a percentage of water absorbed of less than 5.5%. DMSO may be considered highly hygroscopic for readily absorbing moisture from the air at about 11-12% water absorbed. NMP and DMAc may be considered moderately hygroscopic for absorbing moisture from the air over time and not as readily as DMSO at about 7.5-8% water absorbed. The slightly hygroscopic solvent may absorb moisture from the air but not to a significant degree at about less than 7.5% water absorbed.

The solvent may rapidly dissolve the active ingredient (e.g., nitrogen stabilizer). Rapid dissolution may involve less application of agitation or mixing for a lesser duration. The solvent can rapidly dissolve high concentrations of the active ingredient (e.g., NBPT), such as 5 wt %-55 wt %, 5 wt %-50 wt %, 10 wt %-30 wt %, at least 15 wt %, at least 25 wt %, or at least 35 wt % of the active ingredient in the formulation. The dissolution rate is the speed at which a solute dissolves in a solvent, usually expressed as the amount of solute that dissolves per unit time. The suitable dissolution rate of the active ingredient by the solvent may be at least 1 mg/min. The agitation intensity is the speed or force of stirring, shaking, or other forms of agitation applied to the solution. Suitable agitation intensity may be less than 500 rpm, less than 100 rpm, 10-99 rpm, or less than 10 rpm.

The solvent may be a polar solvent that can easily dissolve ionic compounds and other polar substances due to the strong dipole-dipole interactions. The solvent may have a dielectric constant (Er) of at least 15, at least 30, at least 32, at least 34, at least 35, or at least 36. The solvent may be a polar aprotic solvent that can stabilize cations through dipole interactions but cannot donate hydrogen atoms for hydrogen bonding, resulting in less effective solvation of anions.

A suitable solvent for dissolving the active ingredient may include a heterocyclic compound. Heterocyclic compounds include any ring structure containing at least one heteroatom. Ring structures can vary in size, typically containing three to seven members, such as 3-membered rings, 4-membered rings, 5-membered rings, 6-membered rings, 7-membered rings, and so on. In some examples, the solvent includes a 5-membered ring.

A heteroatom is a non-carbon atom (e.g., nitrogen, oxygen, sulfur, phosphorous, boron. In some examples, the solvent includes a heterocyclic compound containing one heteroatom. In some examples, the solvent includes a heterocyclic compound containing one nitrogen atom. In some examples, the solvent includes a heterocyclic compound containing two heteroatoms. In some examples, the solvent includes a heterocyclic compound containing two heteroatoms, one of which is a nitrogen atom. In some examples, the solvent includes a heterocyclic compound containing two heteroatoms, such as a nitrogen atom and an oxygen atom. In some examples, the solvent includes a 5-membered ring with two heteroatoms, such as a nitrogen atom and an oxygen atom.

The ring structure may include a carbonyl group. Examples of different ring structures containing a carbonyl group include lactams, lactones, cyclic ketones, and cyclic esters and imides. The carbonyl group in the ring structure may be bonded to one or more heteroatoms, such as one or both of a nitrogen atom and an oxygen atom. In some examples, the solvent includes a 5-membered ring with a nitrogen atom, an oxygen atom, and a carbonyl group. In some examples, the solvent includes a 5-membered ring with a nitrogen atom, an oxygen atom, and a carbonyl group bonded to both the nitrogen atom and the oxygen atom.

A suitable solvent may include chemicals from the family of azolidinones (nitrogen-containing heterocyclic compounds with a carbonyl group in the ring and an additional heteroatom such as oxygen, sulfur, or nitrogenin the ring as well), such as from the class of oxazolidinones. Oxazolidinones belong to the class of heterocyclic compounds and are characterized by the presence of the oxazolidinone ring. Oxazolidinones are a class of five-membered cyclic organic compounds containing an oxygen atom, a nitrogen atom, and a carbonyl group. Oxazolidinones may have the general formula (I):

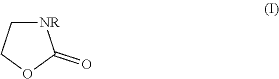

where R is a hydrogen atom, an alkyl group with one or more carbon atoms, or a cyclic structure with three or more members. In some examples, R is a methyl group. In some examples, the suitable solvent includes 3-methyl-2-oxazolidinone. MeOx is available as JEFFSOL® MEOX from Huntsman Corporation, The Woodlands, Texas. The CAS Number of MeOx may be 19844-06-9. The IUPAC name of MeOx is 3-Methyl-1,3-oxazolidin-2-one. 3-methyl-2-oxazolidinone (MeOx) has the molecular formula C₄H₇NO₂. The molecular weight of MeOx may be 101.10 g/mol. Depending on the temperature, MeOx may be colorless to pale yellow liquid. The melting point of MeOx may be approximately 15° C. The boiling point of MeOx may be about 214-216° C. at atmospheric pressure. MeOx may have a flash point of approximately 83-87° C. (189° F.). The density of MeOx may be approximately 1.15 g/cm³ at 20° C.

MeOx may be less toxic than other solvents, such as DMSO, NMP, and DMac. MeOx may have an LD₅₀ (oral, rat) of approximately 1,500-2,000 mg/kg, LD₅₀ (dermal, rabbit) of approximately 1,500-2,000 mg/kg, is not classified by a regulatory agency as a reproductive hazard, permeability coefficient (Kp) of approximately 1.0×10⁻⁵ cm/s, and flux of approximately 0.1-1.0 μg/cm²/h.

MeOx may be a slightly hygroscopic solvent, absorbing moisture from the air but not to a significant degree at about less than 7.5% water absorbed or at about less than 6% water absorbed.

MeOx may be highly soluble in water and polar organic solvents. MeOx may be used as a polar aprotic solvent. The dielectric constant of MeOx may be 77 at room temperature (as reported in Journal of Solution Chemistry, Vol. 1, No. 2, 1972). The active ingredient(s) (e.g., nitrogen stabilizer) may be readily or efficiently dissolved into MeOx, such as rapidly at a dissolution rate of at least 1 mg/min and minimal agitation rate of less than 500 rpm.

When MeOx and active ingredient(s) (e.g., nitrogen stabilizer) are combined, the active ingredient(s) should not be crystallized out of the formulation under normal storage conditions (−20° C.-40° C.). MeOx may prevent crystallization or precipitation from occurring at any temperature (e.g., at or below freezing or 0 degrees Celsius).

Crystallization is a process in which a solid forms from a solution or melt. This process can occur when the concentration of a solute exceeds its solubility limit in a solvent, or when conditions favor the formation of a solid phase. Crystallization occurs when the solute (nitrogen stabilizer) exceeds its solubility limit in the solvent. This may result in the formation of solid crystals, which can clog equipment, such as sprayers or distribution systems. Factors, such as temperature fluctuations, concentration changes, or the presence of impurities, can lead to crystallization. This can reduce the solubility of the stabilizer and can leave undissolved particles in the mixture. Crystallized stabilizers may not be uniformly distributed when applied, leading to uneven nutrient delivery and reduced effectiveness. In agricultural applications, this can impact crop growth and nutrient uptake.

Precipitation in the context of nitrogen stabilizers involves the formation of solid particles from a solution or mixture containing the stabilizer. This can be a significant issue for the effectiveness, application, and handling of nitrogen stabilizers used in agriculture. If the concentration of the nitrogen stabilizer in a solution exceeds its solubility limit, it can lead to precipitation. This might happen if the solution becomes supersaturated due to concentration increases or temperature drops. Cooling a solution or mixture containing a nitrogen stabilizer can reduce its solubility, causing it to precipitate out. Temperature fluctuations during storage or application can exacerbate this issue. Precipitation can occur if the nitrogen stabilizer reacts with other components in the formulation, resulting in the formation of an insoluble product. For example, if the nitrogen stabilizer reacts with hard water ions or other chemicals, it may form precipitates. The solubility of some nitrogen stabilizers can be affected by changes in pH. A shift in pH can lead to the formation of insoluble compounds that precipitate out of solution.

The agrochemical formulation may include 5 wt %-55 wt %, 5 wt %-50 wt %, at least 35 wt %, at least 45 wt %, or at least 49 wt % MeOx.

The agrochemical formulation may include at least one co-solvent. The suitable solvent may be compatible with at least one co-solvent. Co-solvents may include glycols, glycol ethers, amines, low molecular weight amines, alkanolamines, amides, sulfoxides, and water. Amines can add additional stabilizing functionality to the formulation. Examples of co-solvents include ethylene glycol (EG), propylene glycol (PG), benzyl alcohol, butyl benzoate, benzyl acetate, propylene carbonate, mixtures of C6-C18 saturated hydrocarbons, alkylated aromatic solvents, triethanolamine dimethylsulfoxide (TEA), diglycolamine (DGA), hydroxyethylmorpholine, monoethanolamine, DMSO, and diethanolamine (DEA). Solvents and co-solvents may have similar polarity to ensure mutual solubility and avoid phase separation. Polar solvents (e.g., water, methanol) may mix well with other polar solvents, while non-polar solvents (e.g., hexane, toluene) may be compatible with non-polar co-solvents. Since EG, PG, TEA, DMSO, and DEA may be considered polar solvents, the suitable solvent may also be a polar solvent. Solvents that can form hydrogen bonds (e.g., alcohols, water) are generally compatible with other hydrogen-bonding solvents. However, mixing a hydrogen-bonding solvent with one that cannot form hydrogen bonds (e.g., hydrocarbons) might lead to incompatibility. Therefore, the suitable solvent should have similar hydrogen-bonding capability as the co-solvents, which have the capability of accepting or donating hydrogen atoms for hydrogen bonding. The suitable solvent may be miscible with the co-solvent in the desired concentration range, meaning the suitable solvent and co-solvent may mix in all proportions without separating into layers. The suitable solvent may be chemically stable with co-solvents (e.g., little or no undesirable reaction(s) between solvent and co-solvent(s)). The suitable solvent may have a viscosity that is not significantly different from the co-solvent(s) so the solvent is not incompatible with the co-solvent(s).

The agrochemical formulation may include at least one colorant, which can be a soluble dye or a dispersed pigment. The colorant may be less than 5 wt %, less than 1 wt %, less than 0.1 wt %, less than 0.01 wt %, or less than 0.001 wt % of the formulation. The colorant may indicate that an ingredient (e.g., nitrogen stabilizer) has been added as well as the amount of the ingredient. The ingredient (e.g., nitrogen stabilizer) may be added after another ingredient (e.g., nitrogen fertilizer) has been deposited on the soil. The suitable solvent may be compatible with a colorant, such as a dye or a pigment. Pigments may be particles that are dispersed in a medium, while dyes may be soluble substances that dissolve in the solvent or mixture of solvents. The suitable solvent and colorant may cause minimal, if any, problems with solubility of the components in the agrochemical formulation. The suitable solvent may dissolve the dye; the dye may be soluble in the suitable solvent. The pigment particles may be uniformly distributed in the suitable solvent. Examples of colorants include azo dyes, anthraquinone dyes, phthalocyanine dyes, natural dyes, tannin dyes, textile dyes, food dyes, cosmetic dyes, industrial dyes, water-soluble dyes, oil-soluble dyes, fat-soluble dyes, fluorescent dyes, photochromic dyes, and thermochromic dyes. The dye may be a green dye. Green dyes may be natural green dyes, synthetic green dyes, green pigments in textiles and paints, or food dyes. Examples of green dyes that may be used in fertilizers may be FD&C Green No. 3 or chlorophyll-based dyes. Green dyes may be obtained by mixing primary colors. Examples of pigments include azo pigments, phthalocyanine pigments, quinacridone pigments, dye-based organic pigments, metallic pigments, earth pigments, chromium pigments, cadmium pigments, fluorescent pigments, photochromic pigments, thermochromic pigments, and luminescent pigments.

The agrochemical formulation may include at least one surfactant. Surfactants may be used to improve the effectiveness and handling properties of the agrochemical formulation. Surfactants may be used as a wetting agent to help the active ingredient (e.g., nitrogen stabilizers) spread more evenly on soil, foliar substrates, or fertilizer surfaces, improving their penetration and effectiveness. Surfactants may aid in the formation of stable emulsions when the active ingredient (e.g., nitrogen stabilizers) are mixed with other liquid components, ensuring uniform application. Surfactants may lower the surface tension of the solution (e.g., fertilizer solution) and enhance the ability of the active ingredient (e.g., nitrogen stabilizer) to penetrate and adhere to soil or fertilizer particles. Surfactants may help in breaking up and dispersing solid particles of the active ingredient (e.g., nitrogen stabilizer), ensuring they remain evenly distributed in the solution. Surfactants may improve the compatibility of active ingredients (e.g., nitrogen stabilizers) with other components in the formulation (e.g., fertilizer formulation), reducing the likelihood of separation or settling. Examples of surfactants may include non-ionic surfactants, anionic surfactants, cationic surfactants, and amphoteric surfactants. Surfactants may include polysorbates (e.g., polysorbate 80), fatty alcohol ethoxylates, and sorbitan esters (e.g., Span 20).

An additive (e.g., nitrogen stabilizer) dissolved in a solvent (e.g., 3-methyl-2-oxazolidinone) may be added to an agrochemical input (e.g., nitrogen fertilizer). The agrochemical input (e.g., nitrogen fertilizer) may be stored in a container or deposited onto soil. The dissolved additive (e.g., nitrogen stabilizer in 3-methyl-2-oxazolidinone) may be sprayed or coated onto the agrochemical input (e.g., nitrogen fertilizer) while it is in the container or on the soil. The dissolved additive (e.g., nitrogen stabilizer in 3-methyl-2-oxazolidinone) may be mixed with the agrochemical input (e.g., nitrogen fertilizer) prior to storage. The container may include a barrel attached to a sprayer (e.g., Graco sprayer) for spray blasting the dissolved additive. The barrel may be sizable and configured to rotate. The container may contain the dissolved additive for spraying or coating onto the agrochemical input that has been placed on the soil. In some examples, the container may contain a liquid formulation of the agrochemical input and the dissolved additive for spray blasting at the soil. The agrochemical input may be dissolved to create a liquid solution prior to being added or when added to the container with the dissolved additive. Dissolution of the agrochemical input may occur through addition of solvent(s) prior to or after being combined with the dissolved additive. In some cases, the solvent used to dissolve the additive may be in a sufficient amount to also dissolve the agrochemical input. The container may be rotated to combine the dissolved additive and the agrochemical input. Approximately a gallon of dissolved additive (e.g., nitrogen stabilizer in solvent) may be applied per ton of agrochemical input (e.g., urea). Because crystallization and precipitation of the additive and/or agrochemical input can clog a spray or fail to exit the sprayer, the solvent may be selected to prevent crystallization or precipitation of the additive and/or agrochemical input. Crystallized or precipitated particles of the additive and/or agrochemical input may remain in the sprayer instead of being applied to soil, reducing the effectiveness of the agrochemical input, causing product waste, leading to operational inefficient, customer dissatisfaction, and adverse soil impact. If the dissolved additive was combined with solid agrochemical input without a sprayer, precipitates or crystals may cause uneven application of the dissolved additive with the solid agrochemical input.

Addition of nitrogen stabilizers to some fertilizer mixtures can greatly increase moisture absorption into the fertilizer, causing it to clump together and become difficult to process and spread using commercially available farm equipment. Any solvent used in these processes should keep moisture absorption to a minimum, however most common polar aprotic solvents used in the agrochemical industry, like DMSO, may be hygroscopic. Most non-hygroscopic solvents may not be strong enough to dissolve nitrogen stabilizers. Example 1 compares the hygroscopic nature of MeOx to other solvents commonly used in the agrochemical industry.

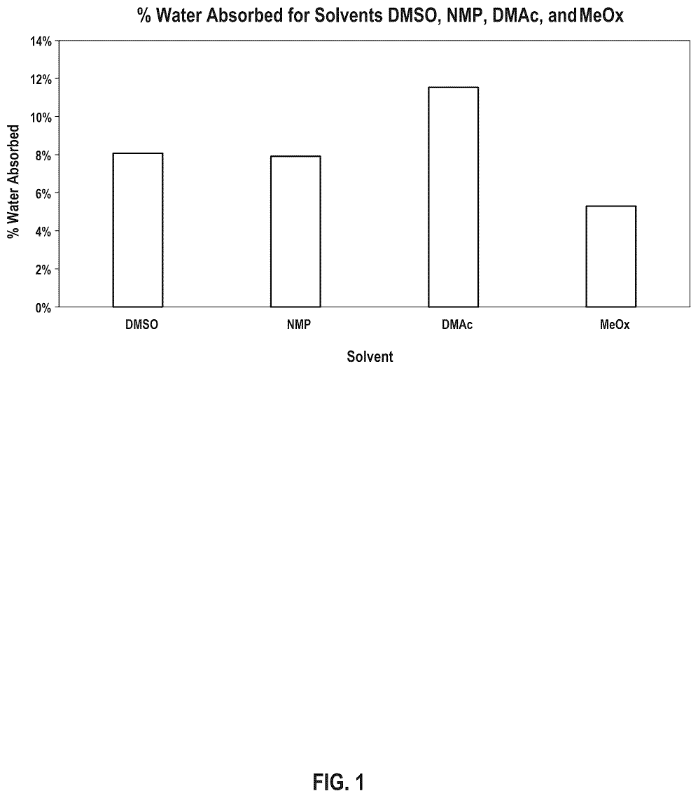

Example 1: The hygroscopicity of the solvents DMSO, NMP, DMAC, and MeOx were tested. Open beakers of each solvent were placed in a humidity chamber set at 33.5° C. and 60% relative humidity. The change in weight due to moisture absorption for each solvent was measured over a four-hour period. The percent water absorbed by each solvent was determined by comparing its final weight after exposure to humidity with its original weight. FIG. 1 shows the hygroscopicity results for DMSO, NMP, DMac, and MeOx. As shown in FIG. 1, MeOx has the lowest hygroscopicity of the tested solvents.

The addition of the solvent should maintain freeze-thaw stability, prevent or avoid crystallization (e.g., does not cause crystallization), and ensure pumpability and sprayability at low temperatures (36-40° F.). The agrochemical formulation may be stored at temperatures below freezing or applied at temperatures slightly above freezing. If the formulation freezes, it is desirable that the formulation bulk freeze like water freezes and thaws without a separation of phases rather than thawing out into two layers or crystallizing an active ingredient. If the formulation remains liquid, it is undesirable for crystallization or precipitation to occur. When crystallization, precipitation, or formation of two layers occurs, it may require the extra effort of heating or stirring to dissolve the particles back into the formulation. While crystallization and formation of two layers after thawing are both undesirable, crystallization may cause significant issues with a spray nozzle and crystals of active ingredient may remain in the container rather than sprayed out. Comparative Example 2 and Example 1 were used to compare nitrogen-containing fertilizers without or with MeOx, observing for freeze/thaw cycling, crystallization, odor, and color intensity. NBPT is a sulfur containing compound that may release an odor. Odor and color changes may be a sign that NBPT may be breaking down. The addition of MeOx did not cause freeze/thaw instability or crystallization. The addition of MeOx does not appear to affect the stability of the formulation as there was no odor or color changes in the formulation.

Comparative Example 1: A formulation without MeOx as shown in Table C1 was evaluated at different temperatures. The formulation froze solid below 25° C. indicating poor handling properties for cooler weather, and during heated storage the formulation emitted a strong odor indicative of NBPT degradation.

TABLE C1

| Component | wt. % |
|---|---|
| NBPT | 25% |
| PG | 75% |
| Green dye | 1% |

Comparative Example 2: A formulation with the composition without MeOx as shown in Table C2 was evaluated at different temperatures. During cold storage, the formulation was monitored for crystallization of the active ingredient or phase separation following freeze/thaw cycling. During heated storage, the formulation was monitored for odor and color changes. After at least 2 weeks of cold storage at temperatures below 0° C., the formulation did not freeze or crystallize. After at least 6 weeks of heated storage at 40° C., both the odor and color intensity increased.

TABLE C2

| Component | wt. % |
|---|---|
| NBPT | 15% |
| DCD | 15% |
| DMSO | 69% |
| Green dye | 1% |

Comparative Example 3: A formulation with the composition in Table C3 without MeOx was evaluated at different storage temperatures. During cold storage, the product froze solid and did not fully thaw back into a usable liquid when stored above freezing for a day.

TABLE C3

| Component | wt. % |
|---|---|
| NBPT | 25% |
| Glycol Ether EB | 34.3% |
| TEA | 30% |
| EG | 1% |
| Blue Dye | 0.7% |

Example 1: A formulation with the composition with MeOx as shown in Table E1 was evaluated at different temperatures. During cold storage, the formulation was monitored for crystallization of the active ingredient or phase separation following freeze/thaw cycling. During heated storage, the formulation was monitored for odor and color changes. After at least 2 weeks of cold storage at temperatures below 0° C., the formulation did not freeze or crystallize. After 1 year of heated storage at 40° C., no changes in odor and minimal changes in color were observed.

TABLE E1

| Component | wt. % |
|---|---|
| NBPT | 15% |
| DCD | 15% |
| MeOx | 49% |
| DMSO | 15% |
| diglycolamine | 5% |
| Green dye | 1% |

Mixtures of ammonium sulfate (AMS) and urea notoriously absorb moisture and become clumpy in medium to high humidity environments. Addition of nitrogen stabilizer formulations can make this phenomenon worse, and depending on the formulation, render the fertilizer un-spreadable. Example 2 examines the effect of MeOx on AMS/urea fertilizers in moisture absorption.

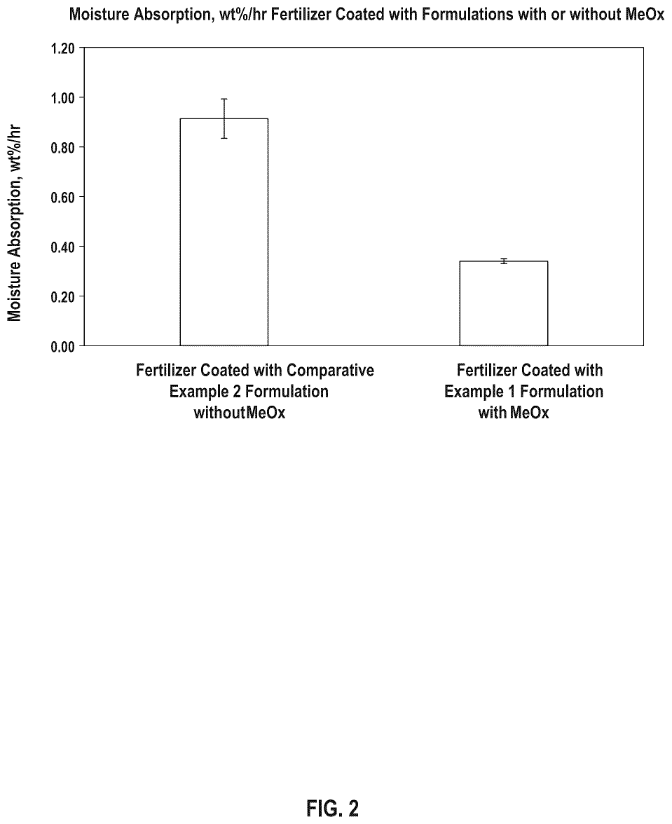

Example 2: The moisture absorptions of the formulations of Comparative Example 2 without MeOx and Example 1 with MeOx were tested. Each formulation was coated onto a fertilizer mixture of 80 wt % urea and 20 wt % AMS at a use rate equal to a gallon per ton of fertilizer. The coated fertilizers were then placed in a humidity chamber at 33.5° C. and 60% RH for three to four hours. The change in mass of each sample was determined. Experiments were run in triplicate. FIG. 2 shows the moisture absorption by fertilizer coated with Comparative Example 2 formulation without MeOx and Example 1 formulation with MeOx. As shown in FIG. 2, the fertilizer coated with Example 1 formulation with MeOx absorbed moisture at a rate that is about less than three times than that of the fertilizer coated with Comparative Example 2 formulation.

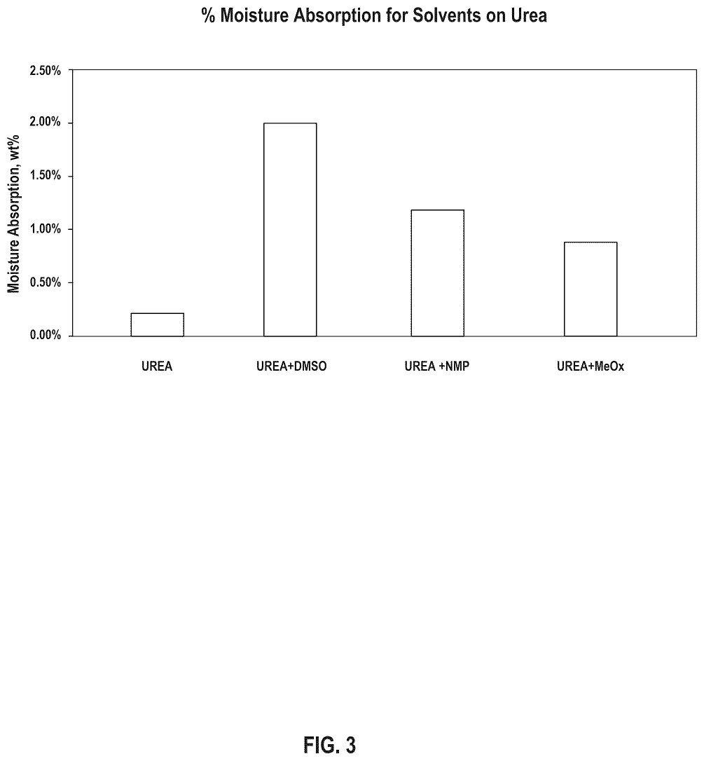

Example 3: The coating of different solvents onto fertilizers can change their moisture absorption properties, making them clump faster after coating and increasing processing difficulties. To compare the inventive solvent to other industry standards, 50 g of urea fertilizer was coated with DMSO, NMP, or MeOx and placed in a temperature-controlled humidity chamber at 60% RH and 33.5° C., and the change in mass of the fertilizer was measured after 15 hours of exposure. FIG. 3 shows the hygroscopicity results for urea, urea with DMSO, urea with NMP, and urea with MeOx. As illustrated in FIG. 3, urea with MeOx had the smallest effect on moisture absorption of the three solvents evaluated.

Example 4: A formulation with the composition in Table E4 was observed. NBPT and DCD dissolved rapidly with minimal mixing. The formulation was stable for 1 year under normal storage conditions ranging from −20° C. to 40° C., and repeated freeze/thaw cycling did not induce crystallization of the NBPT or DCD

TABLE E4

| Component | wt. % |
|---|---|
| NBPT | 15% |
| DCD | 15% |
| MeOx | 49% |
| DMSO | 15% |
| isopropanolamine | 5% |
| Blue dye | 1% |

Example 5: A formulation with the composition shown in Table E5 was observed. NBPT dissolved rapidly with minimal mixing or minimal duration of mixing. At 0° C., the formulation was flowable, and no crystallization was observed. The formulation was stable for 1 year under normal storage conditions ranging from −20° C. to 40° C., and repeated freeze/thaw cycling did not induce crystallization of the NBPT.

TABLE E5

| Component | Wt. % |
|---|---|
| NBPT | 25% |
| MeOx | 35% |
| TEA | 30% |
| EG | 10% |

Example 6: A formulation with the composition shown in Table E6 was observed. NBPT dissolved rapidly with minimal mixing or minimal duration of mixing. At 0° C., the formulation was flowable, and no crystallization was observed. The formulation was stable for 1 year under normal storage conditions ranging from −20° C. to 40° C., and repeated freeze/thaw cycling did not induce crystallization of the NBPT.

TABLE E6

| Component | Wt. % |
|---|---|
| NBPT | 25% |
| MeOx | 45% |
| DEA | 5% |
| EG | 25% |

Example 7: A formulation with the composition shown in Table E7 was observed. Formulations with >35% NBPT are difficult to formulate due to the effect of NBPT raising the freezing point or crystallizing out of solution. NBPT dissolved rapidly with minimal mixing or minimal duration of mixing. At 0° C., the formulation was flowable, and no crystallization was observed. At −20° C., the formulation froze but thawed back homogeneously at 2° C., indicating favorable freeze/thaw properties. The formulation was stable for 1 year under normal storage conditions ranging from −20° C. to 40° C., and repeated freeze/thaw cycling did not induce crystallization of the NBPT.

TABLE E7

| Component | Wt. % |
|---|---|
| NBPT | 40% |
| MeOx | 45% |
| DGA | 10% |
| PG | 5% |

Example 8: A formulation with the composition shown in Table E8 was observed. Formulations with >35% NBPT are difficult to formulate due to the effect of NBPT raising the freezing point or crystallizing out of solution. NBPT dissolved rapidly with minimal mixing or minimal duration of mixing. At 0° C., the formulation was flowable, and no crystallization was observed. At −20° C., the formulation remained flowable and crystal growth was not observed after 6 weeks of storage at −20° C. The formulation was stable for 1 year under normal storage conditions ranging from −20° C. to 40° C., and repeated freeze/thaw cycling did not induce crystallization of the NBPT.

TABLE E8

| Component | Wt. % |
|---|---|
| NBPT | 40% |
| MeOx | 35% |
| DEA | 10% |
| DMSO | 15% |

Example 9: Inclusion of dyes—Examples 5-8 were formulated with blue and green dyes. No negative formulation effects from the dyes were observed.

The following clauses illustrated example subject matter described herein.

Clause 1. An agrochemical formulation comprising: an active ingredient, and a solvent for dissolving the active ingredient, the solvent comprising a heterocyclic compound having a ring structure and at least two different heteroatoms in the ring structure.

Clause 2. An agrochemical formulation comprising: a solvent comprising at least one heterocyclic compound having a ring structure and at least two different heteroatoms in the ring structure and a plant-targeted or soil-targeted agrochemical active ingredient that biochemically interacts with a plant or soil.

Clause 3. An agrochemical formulation comprising: an agrochemical input for improving crop yield, the agrochemical input having a high concentration of an active component, the active component comprising one or more of nitrogen, potassium, phosphate, calcium magnesium or micronutrient, an agrochemical additive for maintaining the active component in plants or soil, and a solvent comprising at least one heterocyclic compound having a ring structure and at least two heteroatoms in the ring structure.

Clause 4. The agrochemical formulation of any one of clauses 1 through 3, wherein the at least one heterocyclic compound comprises an oxazolidinone.

Clause 5. The agrochemical formulation of any one of clauses 1 through 4, wherein the at least one heterocyclic compound comprises 3-methyl-2-oxazolidinone.

Clause 6. The agrochemical formulation of any one of clauses 1 through 5, wherein the at least one heterocyclic compound is 30 wt % to 55 wt % of the agrochemical formulation.

Clause 7. The agrochemical formulation of clause 2, wherein the plant-targeted or soil-targeted agrochemical is a nitrogen stabilizer.

Clause 8. The agrochemical formulation of clauses 1 or 2, further comprising a fertilizer.

Clause 9. The agrochemical formulation of any one of clauses 1 through 8, further comprising a co-solvent.

Clause 10. The agrochemical formulation of any one of clauses 1 through 9, further comprising an odor masking agent.

Clause 11. An agrochemical formulation comprising: a nitrogen stabilizer for reducing nitrogen loss from a nitrogen fertilizer; and a solvent for dissolving the nitrogen stabilizer, the solvent comprising at least one heterocyclic compound having a ring structure and at least two heteroatoms in the ring structure, and the solvent preventing crystallization or precipitation of the agrochemical formulation at temperatures below or equal to zero degrees Celsius.

Clause 12. The agrochemical formulation of claim 11, further comprising a nitrogen fertilizer, wherein the solvent has a hygroscopicity characterized by less than 6% increase in weight after the solvent was placed in a humidity chamber set at 33.5 degrees Celsius and 60% relative humidity for four hours to prevent clumping of the nitrogen fertilizer when the nitrogen stabilizer is combined with the nitrogen fertilizer.

Clause 13. The agrochemical formulation of claim 11 or 12, wherein the ring structure of the heterocyclic compound comprises a carbonyl group bonded to the at least two heteroatoms, the at least two heteroatoms comprising a nitrogen atom and an oxygen atom.

Clause 14. The agrochemical formulation of any one of claims 11 through 13, wherein the at least one heterocyclic compound comprises an oxazolidinone.

Clause 15. The agrochemical formulation of any one of claims 11 through 14, wherein the at least one heterocyclic compound comprises 3-methyl-2-oxazolidinone.

Clause 16. The agrochemical formulation of any one of claims 11 through 15, wherein the nitrogen stabilizer comprises one or more of thiophosphoric triamide, dicyanamide, and di-alkylpyrazole salt.

Clause 17. The agrochemical formulation of any one of claims 11 through 16, wherein the nitrogen stabilizer comprises at least 25 wt % thiophosphoric triamide of the agrochemical formulation.

Clause 18. The agrochemical formulation of any one of claims 11 through 17, further comprising a co-solvent, the co-solvent comprising one or more of ethylene glycol (EG), propylene glycol (PG), triethanolamine (TEA), DMSO, diglycol amine, and diethanolamine (DEA).

Clause 19. The agrochemical formulation of any one of claims 11 through 18, further comprising a nitrogen fertilizer, wherein the nitrogen fertilizer comprises one or more of urea, ammonium sulfate, and ammonium phosphates.

Clause 20. The agrochemical formulation of any one of claims 11 through 19, further comprising an herbicide, biostimulant, sporulated microbes, or polyamino acid.

Clause 21. The agrochemical formulation of claim any one of claims 11 through 20, further comprising a colorant.

Clause 22. The agrochemical formulation of any one of claims 11 through 21, wherein the solvent has a flash point of at least 80 degrees Celsius.

Clause 23. A method of producing an agrochemical formulation, wherein the method comprises: dissolving a nitrogen stabilizer in a solvent, the solvent comprising at least one heterocyclic compound having a ring structure and at least two heteroatoms in the ring structure, and the solvent preventing crystallization or precipitation of the agrochemical formulation at temperatures below or equal to zero degrees Celsius.

Clause 24. The method of claim 23, wherein the solvent is 30 wt % to 55 wt % of the agrochemical formulation.

Clause 25. The method of claim 23 or 24, wherein the at least one heterocyclic compound comprises oxazolidinone.

Clause 26. The method of any one of claims 23 through 25, wherein the agrochemical formulation comprises a co-solvent, the solvent being mixed with the co-solvent.

Clause 27. A method of delivering an agrochemical formulation to plants or soil, wherein the method comprises: applying a mixture of a plant-targeted or soil-targeted agrochemical additive dissolved in a solvent comprising at least one heterocyclic compound to a plant-targeted or soil-targeted agrochemical input to produce the agrochemical formulation, the solvent has a hygroscopicity characterized by less than 6% increase in weight after the solvent was placed in a humidity chamber set at 33.5 degrees Celsius and 60% relative humidity for four hours to prevent clumping of the plant-targeted or soil-targeted agrochemical input when the plant-targeted or soil-targeted agrochemical additive is combined with the plant-targeted or soil-targeted agrochemical input, and the solvent preventing crystallization or precipitation of the agrochemical formulation at temperatures below or equal to zero degrees Celsius.

Clause 28. The method of claim 27, wherein the plant-targeted or soil-targeted agrochemical input comprises a nitrogen-containing fertilizer, the nitrogen-containing fertilizer comprising one or more of urea, ammonium sulfate, and ammonium phosphate.

Clause 29. The method of claim 27 or 28, wherein the agrochemical formulation comprises a co-solvent.

Clause 30. The method of any one of claims 27 through 29, wherein the at least one heterocyclic compound comprises 3-methyl-2-oxazolidinone.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. An agrochemical formulation comprising:
an agrochemical active ingredient; and
a solvent for dissolving the agrochemical active ingredient, wherein the solvent comprises at least one heterocyclic compound having a ring structure and at least one nitrogen and one oxygen in the ring structure.

2. The agrochemical formulation of claim 1, wherein the agrochemical active ingredient comprises a nitrogen stabilizer.

3. The agrochemical formulation of claim 2, further comprising a nitrogen-containing fertilizer, wherein the nitrogen containing fertilizer is coated with the nitrogen stabilizer formulation.

4. The agrochemical formulation of claim 1, further comprising at least one of a liquid fertilizer solution comprising a solution of urea-ammonium nitrate, or a liquid solution of ammonium phosphate.

5. The agrochemical formulation of claim 1, wherein the at least one heterocyclic compound comprises an oxazolidinone.

6. The agrochemical formulation of claim 1, wherein the at least one heterocyclic compound comprises an oxazolidinone of the structure 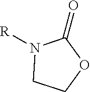
where R is a linear or branched alkyl chain of 1-8 carbons.

7. The agrochemical formulation of claim 1, wherein the at least one heterocyclic compound comprises 3-methyl-2-oxazolidinone.

8. The agrochemical formulation of claim 2, wherein the nitrogen stabilizer comprises one or more of a thiophosphoric triamide, dicyandiamide, and a di-alkylpyrazole salt.

9. The agrochemical formulation of claim 1, wherein the agrochemical active ingredient comprises a nitrogen stabilizer, and wherein the nitrogen stabilizer comprises at least 25 wt % of a thiophosphoric triamide.

10. The agrochemical formulation of claim 1, further comprising a co-solvent, the co-solvent comprising one or more of ethylene glycol, propylene glycol, benzyl alcohol, butyl benzoate, benzyl acetate, propylene carbonate, mixtures of C6-C18 saturated hydrocarbons, alkylated aromatic solvents, triethanolamine, dimethylsulfoxide, diglycolamine, hydroxyethylmorpholine, monoethanolamine, mono-isopropanolamine, and diethanolamine.

11. The agrochemical formulation of claim 1, further comprising a nitrogen fertilizer, wherein the nitrogen fertilizer comprises one or more of urea, ammonium nitrate, ammonium sulfate, and ammonium phosphates.

12. The agrochemical formulation of claim 1, further comprising an insecticide, biostimulant, sporulated microbes, or polyamino acid.

13. The agrochemical formulation of claim 1, further comprising at least one of a colorant or an odor masking agent.

14. The agrochemical formulation of claim 1, wherein the solvent has a flash point of at least 80 degrees Celsius.

15. A method of producing an agrochemical formulation, wherein the method comprises:
dissolving an agrochemical active ingredient in a solvent, wherein the solvent comprises at least one heterocyclic compound having a ring structure and at least one nitrogen and one oxygen in the ring structure.

16. The method of claim 13, wherein the solvent is 30 wt % to 55 wt % of the agrochemical formulation.

17. The method of claim 13, wherein the at least one heterocyclic compound comprises an oxazolidinone.

18. The method of claim 13, wherein the method further comprises mixing the solvent with a co-solvent.

19. A method of delivering an agrochemical formulation to plants or soil, wherein the method comprises:
applying a mixture of an agrochemical active ingredient dissolved in a solvent comprising at least one heterocyclic compound having a ring structure and at least one nitrogen and one oxygen to a plant-targeted or a soil-targeted agrochemical input via spraying or broadcasting,
wherein the solvent has a hygroscopicity characterized by less than 6% increase in weight after the solvent was placed in a humidity chamber set at 33.5 degrees Celsius and 60% relative humidity for four hours to, when the agrochemical active ingredient and the solvent is combined with the plant-targeted or the soil-targeted agrochemical input, prevent clumping of the plant-targeted or the soil-targeted agrochemical input, and
wherein the solvent is selected to prevent crystallization or precipitation of the agrochemical formulation at temperatures below or equal to zero degrees Celsius.

20. The method of claim 17, wherein the plant-targeted or the soil-targeted agrochemical input comprises a nitrogen-containing fertilizer, the nitrogen-containing fertilizer comprising one or more of urea, ammonium sulfate, and ammonium phosphate, wherein the agrochemical formulation further comprises a co-solvent, and wherein the at least one heterocyclic compound comprises 3-methyl-2-oxazolidinone.
